(19) United States
(12) Patent Application Publication
(10) Pub. No.: US 2004/0104673 A1
(43) Pub. Date: Jun. 3, 2004

(54) Electroluminescence display

(76) Inventors: Takehiro Hosokawa, Kanuma-shi (JP); Keiichi Tanaka, Kanuma-shi (JP)

Correspondence Address: MCDERMOTT WILL & EMERY, 600 13TH STREET, N.W., WASHINGTON, DC, 20005-3096, US

(21) Appl. No.: 10/470,420

(22) PCT Filed: Nov. 29, 2002
(86) PCT No.: PCT/JP02/12545

(30) Foreign Application Priority Data
Nov. 29, 2001 (JP) 2001-364823

(51) Int. Cl. H05B 33/00

(52) U.S. Cl. 313/512

(57) ABSTRACT

An EL display device includes a transparent substrate, an electroluminescence element provided on the transparent substrate, and a sealing resin sheet having a function of moisture absorption. The sealing resin sheet is fusion bonded to the transparent substrate by heat to seal the electroluminescence element between the sealing resign sheet and the transparent substrate.

### TECHINAL FIELD

The present invention relates to an electroluminescence display device.

### BACKGROUND ART

In recent years, electroluminescence (hereinafter, simply referred to as “EL” as well) display devices have come to be widely used as information display devices. In general, as shown in FIG. 5, such an EL display device 100 includes a transparent substrate 102 as a faceplate, an EL element 104 formed on the transparent substrate 102, and a sealing body 106 for sealing the EL element 104.

The EL element 104 has transparent electrodes 108, back electrodes 110, and a light-emitting portion 112 provided between these electrodes. The sealing body 106 is constituted of a molded stainless steel body, and has a housing portion 106a for housing the EL element 104 and a flange portion 106b used to join the sealing body 106 to the transparent substrate 102. Moreover, drying agent 114 is housed in the housing portion 106a. The sealing body 106 is joined onto the transparent substrate 102 through the flange portion 106b by ultraviolet (UV) curing resin 116 in the state of where the EL element 104 is housed in the housing portion 106a.

Accordingly, the EL element 104 is sealed with the sealing body 106 and the moisture within the sealing body 106 is absorbed by the drying agent 114, where by the EL element 104 is prevented from being wet.

### DISCLOSURE OF THE INVENTION

As a result of investigation into the above-described conventional art, the present inventor has discovered the following problems. Specifically, in the known EL display device described above, since a space has been required within the housing portion of the sealing body for housing the drying agent, the thickness of the sealing body has increased correspondingly, causing the EL display device to be large.

Moreover, the ultraviolet curing resin used to join the sealing body and the transparent substrate together has high moisture permeability, and moisture enters inside the sealing body even after the EL element is sealed. Therefore, it has been infeasible to sufficiently suppress the EL element from being wet. Thus, the EL element has been deteriorated with time, and it has been difficult to achieve the long lifetime of the EL display device.

The present invention has been accomplished in light of the above-described circumstances, and an object of the present invention is to provide a small EL display device capable of sufficiently suppressing an EL element from being wet and achieving the long lifetime of the EL display device.

An EL display device according to the present invention includes (1) a transparent substrate, (2) an electroluminescence element provided on the transparent substrate, and (3) a sealing resin sheet having a function of moisture absorption. The sealing resin sheet is fusion bonded to the transparent substrate by heat to seal the electroluminescence element between the sealing resin sheet and the transparent substrate.

In this EL display device, the sealing resin sheet having the function of moisture absorption is fusion bonded to the transparent substrate by heat, whereby the EL element is sealed between the transparent substrate and the sealing resin sheet. Therefore, compared to the conventional case where an EL element is sealed with a molded stainless steel body, the EL display device is thinner corresponding to the fact that a space for housing drying agent is no longer needed, and consequently achieving miniaturization of the device. Moreover, the sealing resin sheet is fusion bonded to the transparent substrate by heat without using adhesive with high moisture permeability such as ultraviolet curing resin, and the sealing sheet itself has the function of moisture absorption. Therefore, moisture is prevented from entering from the bonded portion. As a result, the EL element is sufficiently suppressed from being wet, thus enabling the device to have a long lifetime.

In the EL display device according to the present invention, the sealing resin sheet is preferably fusion bonded to the transparent substrate by heat through a peripheral portion of the sealing resin sheet. This reduces a possibility that the EL element will be damaged by heat when the sealing resin sheet is fusion bonded to the transparent substrate by heat.

Moreover, in the EL display device according to the present invention, the sealing resin sheet preferably has a moisture trapping layer made of thermoplastic resin to which inorganic filler having a function of moisture absorption is added. This makes it possible to fusion bond the sealing resin sheet to the transparent substrate by heat, because of the thermoplastic resin. Furthermore, the EL element is sufficiently suppressed from being wet by the inorganic filler having the function of moisture absorption.

In the EL display device according to the present invention, it is also preferable that the thermoplastic resin is either polyolefin or modified polyolefin which is adhesive. With this type of thermoplastic resin, it is possible to perform the preferable fusion bonding of the sealing resin sheet to the transparent substrate by heat.

Further, in the EL display device according to the present invention, the inorganic filler preferably contains at least any one of magnesium sulfate, calcium oxide, and calcined hydrotalcite. This type of inorganic filler is preferable because it exerts a moisture absorbing function that sufficiently prevents the EL element from being wet.

Further, in the EL display device according to the present invention, the sealing resin sheet preferably has a metal layer on the outer side of the moisture trapping layer with respect to the electroluminescence element. This reduces a possibility that moisture will enter through the sealing resin sheet into the space sealed with the transparent substrate and the sealing resin sheet.

Furthermore, in the EL display device according to the present invention, the sealing resin sheet preferably has a protective layer for protecting the metal layer. This prevents the metal layer from being exposed to the outside, and reduces a possibility that the sealing performance of the metal layer will be lowered by an external scratch.

Also, in the EL display device according to the present invention, the sealing resin sheet is preferably embossed to have a size capable of housing the EL element. This makes it easy to position the sealing resin sheet when the EL element is sealed with the sealing resin sheet. A possibility is also reduced, that undue stress will be placed on the EL element after sealing, thus inhibiting characteristic deterioration of the EL display device.

In addition, in the EL display device according to the present invention, the electroluminescence element may be an organic electroluminescence element.

A sealing resin sheet according to the present invention is the sealing resin sheet used in the above-described electroluminescence display device. The sealing resin sheet is fusion bonded to the transparent substrate by heat to be capable of sealing the electroluminescence element between the sealing resin sheet and the transparent substrate. The sealing resin sheet also has a function of moisture absorption.

The present invention will be more fully understood by reference to the detailed description below and the accompanying drawings. However, these are shown for the purpose of merely exemplifying the present invention and should not be considered to limit the invention.

### BRIEF DESCRIPTION OF THE DRAWINGS

FIG. 1 is a cross-sectional view showing the structure of an EL display device according to the present embodiment.

FIG. 2 is a rear elevational view showing the structure of the EL display device according to the present embodiment.

FIG. 3 is a cross-sectional view showing the structure of a sealing resin sheet included in the EL display device according to the present embodiment.

FIG. 4 is a cross-sectional view showing the structure of an embossed sealing resin sheet.

FIG. 5 is a cross-sectional view showing the structure of a conventional EL display device.

### BEST MODES FOR CARRYING OUT THE INVENTION

Hereinafter, an embodiment of the present invention will be described in detail with reference to the accompanying drawings. Note that the same reference numerals are used for the same components throughout descriptions of the drawings, and that duplicate descriptions will be omitted.

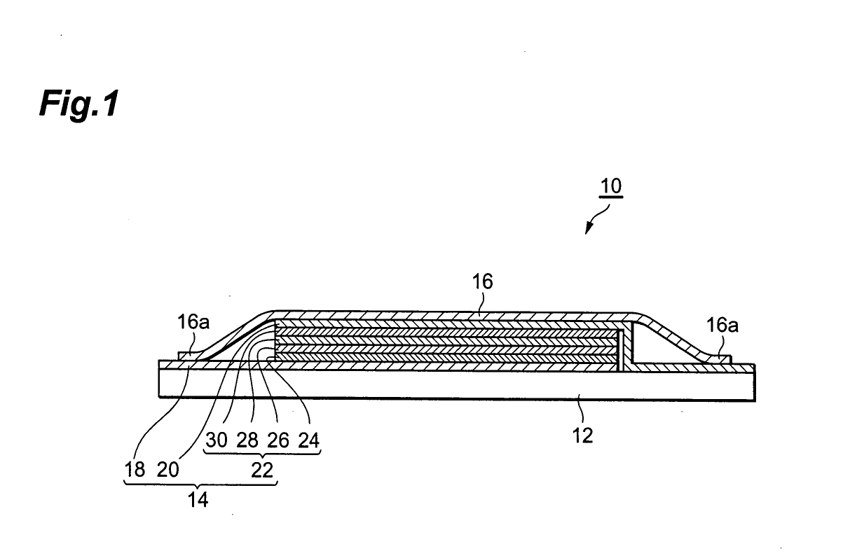

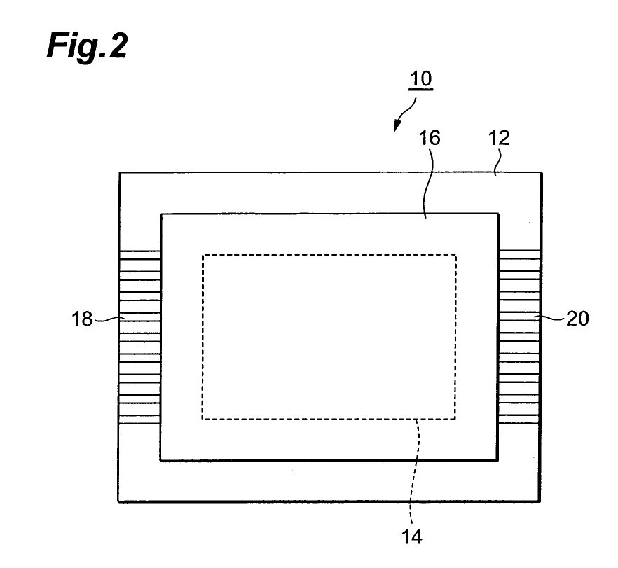

FIG. 1 is a cross-sectional view showing the structure of an electroluminescence (EL) display device according to the present embodiment, and FIG. 2 is a rear elevational view showing the structure of the EL display device. As shown in FIGS. 1 and 2, the EL display device 10 comprises a transparent substrate 12 as a faceplate, an EL element 14 formed on the transparent substrate 12, and a sealing resin sheet 16 for sealing the EL element 14.

The transparent substrate 12 is translucent to visible light and functions as a faceplate, from which the light emitted from the EL element 14 is obtained. The transparent substrate 12 can be constituted of a glass substrate, a resin substrate, or the like. For glass constituting the glass substrate, inorganic glass or the like, such as alkali glass, non-alkali glass, or silica glass can be used. Among these, the use of non-alkali glass, such as barium borosilicate glass, aluminosilicate glass, or the like is preferred from the viewpoints of improvement of heat resistance and avoidance of characteristic deterioration caused by alkali ions. The thickness of the transparent substrate 12 is not particularly limited, but is preferably 0.3 mm to 1.5 mm.

The EL element 14 has transparent electrodes 18 as anodes, back electrodes 20 as cathodes, and a light-emitting portion 22 provided between these electrodes.

The transparent electrodes 18 can be made of indium tinoxide (ITO), indiumantimonyoxide (In—Sb oxide), indium zinc oxide (In—Zn oxide), or the like. Note that the thicknesses of the transparent electrodes 18 are not particularly limited, but preferably 1 μm or smaller.

The back electrodes 20 can be made from metal, such as aluminum (Al), nickel, copper, or the like. The thickness of the back electrodes 20 is not particularly limited, but preferably 50 μm or smaller.

The light-emitting portion 22 can be made of a stack including an organic light-emitting layer. For example, the light-emitting portion 22 can be made by stacking a hole injection layer 24, a hole transport layer 26, an organic light-emitting layer 28, and an electron injection layer 30 in this order on the aforementioned transparent electrodes 18. The materials constituting respective ones of these layers can be appropriately selected from various known materials to be used. For one example for the respective layers, the hole injection layer 24 can be made using copper phthalocyanine (CuPC), the hole transport layer 26 can be made using naphthyl-substituted triphenylamine tetramer (NTPA), the organic light-emitting layer 28 can be made using aluminum 3-hydroxyquinoline (Alq₃) doped with N, N′-dimethyl-quinacridone (DMqd), and the electron injection layer 30 can be made using lithium fluoride (LiF).

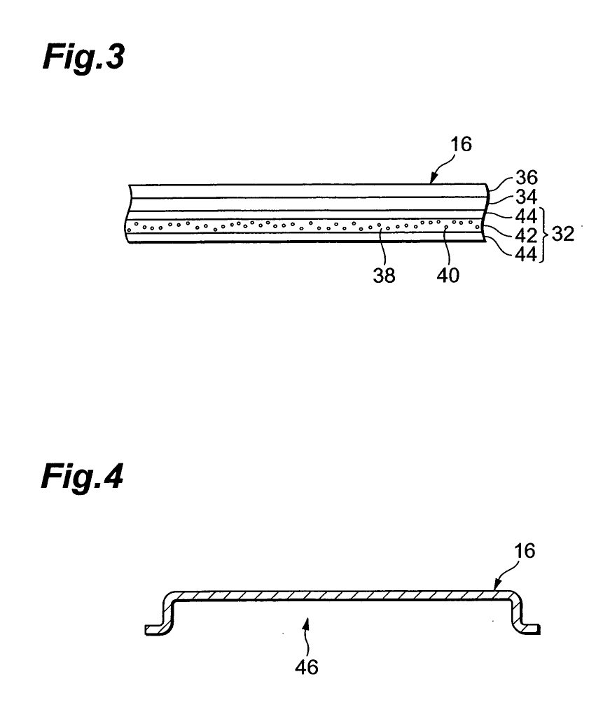

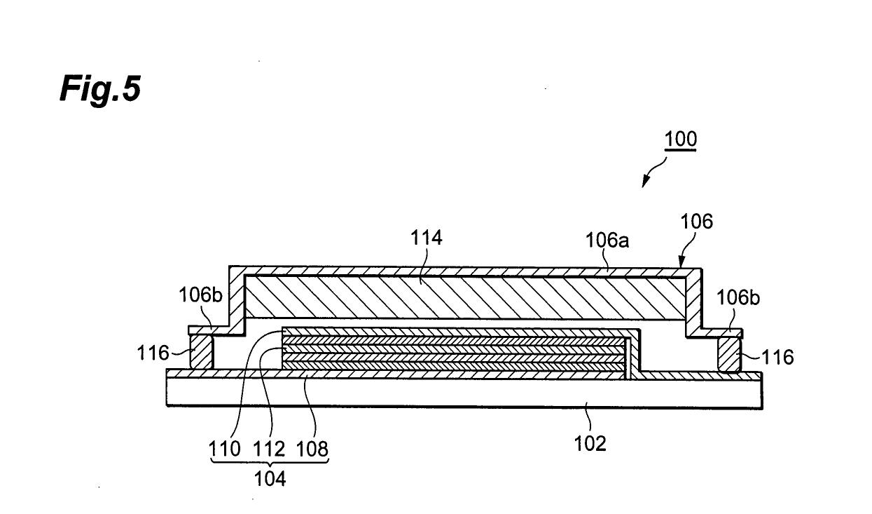

As shown in FIG. 3, the sealing resin sheet 16 has a moisture trapping layer 32 having the function of moisture absorption, a metal layer 34 provided on the moisture trapping layer 32, and a protective layer 36 provided on the metal layer 34.

The moisture trapping layer 32 is formed by mixing inorganic filler 40, as drying agent having hygroscopicity, into thermoplastic resin 38. Preferably, the thermoplastic resin 38 is polyolefin or modified polyolefin which is adhesive. Examples thereof are polyethylene, polypropylene, ionomer, ethylene vinylacetate copolymer (EVA), ethylene ethyl acrylate (EEA), ethyl methacrylate (EMA), acid-modified products thereof, and the like.

For the inorganic filler 40, it is possible to use calcined hydrotalcites from which water of crystallization is removed by sintering, magnesium sulfate, calcium oxide, or the like. More preferably, the magnesium sulfate is anhydrous magnesium sulfate. The inorganic filler 40 is preferably made from particulate matter having an average grain size of approximately 0.1 μm to 10 μm. These inorganic fillers 40 may be used singly or as a combination of two or more kinds thereof as needed. The mixture ratio of the inorganic filler 40 to the binder resin 38 is preferably 5% to 50% by weight to 100% by weight of the total amount of the binder resin 38.

Incidentally, as shown in FIG. 3, the moisture trapping layer 32 may have a three-layer structure in which a core layer 42, made by adding the inorganic filler 40 to the thermoplastic resin 38, is sandwiched between cover layers 44 formed from the aforementioned thermoplastic resin. The thickness of the moisture trapping layer 32 is preferably 5 μm to 150 μm.

The metal layer 34 has a function to prevent moisture from entering through the sealing resin sheet 16 from the outside. The metal layer 34 can be made of foil or an evaporated metal film. As the foil, it is possible to use aluminum foil, stainless steel foil, nickel foil, or the like. The evaporated metal film can be formed by evaporating metal such as aluminum. In particular, it is preferable to use iron-aluminum alloy foil as the metal layer 34. Due to above, the strength of the entire sealing resin sheet 16 is improved, thus reducing a possibility that the sealing resin sheet 16 will tear during embossing which will be described later.

The protective layer 36 prevents the metal layer 34 from being exposed to the outside and has a function to reduce a possibility that the sealing performance of the metal layer 34 will be lowered due to an external scratch. The protective layer 36 can be made from resin or the like having excellent scratch resistance. For the resin constituting the protective layer 36, it is possible to use polyethylene terephthalate (PET), polyamide (nylon), or the like. The thickness of the protective layer 36 is preferably 5 μm to 50 μm.

The above-described protective layer 36 and the metal layer 34 can be adhered to each other by, for example, urethane adhesive or the like. As the urethane adhesive, for example, one obtained by mixing and cross-linking two liquids, polyol and isocyanate, can be used. Moreover, the metal layer 34 and the moisture trapping layer 32 can be joined together by, for example, thermal laminating.

Here, the sealing resin sheet 16 constituted as described earlier can be embossed to have a size capable of housing the EL element 14, as shown in FIG. 4. This makes it easy to position the sealing resin sheet 16 by positioning the sealing resign sheet based on a concave portion 46 formed by embossing, when the EL element 14 is sealed with the sealing resin sheet 16. Moreover, a possibility is reduced, that undue stress will be placed on the EL element 14 after sealing, and deterioration in the characteristics of the EL display device 10 is inhibited.

The EL display device 10 according to the present embodiment is formed as follows: As shown in FIGS. 1 and 2, the EL element 14 provided on the transparent substrate 12 is covered over with the sealing resin sheet 16, and only the peripheral portion 16a of the sealing resin sheet 16 is thermocompression bonded to the transparent substrate 12 to seal the EL element 14. Accordingly, the sealing resin sheet 16 is fusion bonded to the transparent substrate 12 by heat only through the peripheral portion 16a thereof, thereby reducing a possibility that the EL element 14 will be damaged by heat when joining the sealing resin sheet 16 to the transparent substrate 12.

Next, operations and advantages of the EL display device 10 according to the present embodiment will be described.

In the EL display device 10 according to the present embodiment, a sealing resin sheet 16 includes a moisture trapping layer 32 obtained by adding a inorganic filler 40 having a function of moisture absorption to a thermoplastic resin 38. This sealing resin sheet 16 is fusion bonded to a transparent substrate 12 by heat, whereby an EL element 14 is sealed between the transparent substrate 12 and the sealing resin sheet 16. Accordingly, compared to the conventional case where an EL element is sealed with a molded stainless steel body, the thickness of the EL display device 10 is smaller corresponding to the fact that a space for housing drying agent is no longer necessary, which can in turn realize miniaturization of the device. Moreover, the sealing resin sheet 16 is fusion bonded directly to the transparent substrate 12 by heat without using adhesive such as ultraviolet curing resin with a high moisture permeability, and the sealing resin sheet 16 itself also has the function of moisture absorption. Therefore, moisture is prevented from entering from the bonded portion. As a result, the EL element 14 is sufficiently suppressed from being wet, thus making it possible to attain the long lifetime of the device 10.

Moreover, in the EL display device 10 according to the present embodiment, the sealing resin sheet 16 has a metal layer 34 on the outer side of the moisture trapping layer 32 with respect to the EL element 14. Accordingly, it is possible to reduce a possibility that moisture will enter from the outside through the sealing resin sheet 16 into the space sealed with the transparent substrate 12 and the sealing resin sheet 16. Thus, further long lifetime of the device 10 can be achieved.

In addition, in the EL display device 10 according to the present embodiment, the sealing resin sheet 16 has a protective layer 36 for protecting the metal layer 34. Accordingly, it is possible to prevent the metal layer 34 from being exposed to the outside, and to reduce a possibility that the sealing performance of the metal layer 34 will be lowered by an external scratch. Thus, the lifetime of the device 10 can be yet further lengthened.

Furthermore, in the EL display device 10 according to the present embodiment, the sealing resin sheet 16 is embossed to have a size capable of housing the EL element 14. Accordingly, when the EL element 14 is sealed with the sealing resin sheet 16, easy positioning of the sealing resin sheet 16 is possible. Moreover, a possibility is reduced, that undue stress will be placed on the EL element 14 after sealing, thus making it possible to inhibit deterioration in the characteristics of the EL display device 10.

Next, tests conducted to evaluate the waterproof characteristics of the EL display device 10 according to the present embodiment will be described.

(Test Sample 1)

In the preparation of test sample 1, first of all, a 500 mm square PET sheet and a 500 mm square aluminum foil were prepared. Then, the PET sheet and the aluminum foil were adhered to each other with urethane adhesive by a dry laminator to make a PET/Al composite sheet. The thickness of the PET sheet was 12 μm, the thickness of the aluminum foil was 9 μm, and the thickness of the urethane adhesive was 2 μm.

Next, a 500 mm square moisture trapping film having a three-layer structure was made by a three-layer blown film extruder. This moisture trapping film had a three-layer structure of acid-modified polyethylene/acid-modified polyethylene containing magnesium sulfate/acid-modified polyethylene. The thickness of each of these layers was 20 μm. The layer of acid-modified polyethylene containing magnesium sulfate was made by adding 20% by weight of anhydrous magnesium sulfate to 100% by weight of acid-modified polyethylene.

This moisture trapping film was adhered to the Al surface of the PET/Al composite sheet by thermal laminating to make a sealing resin sheet having a structure of PET (protective layer)/Al (metal layer)/moisture trapping film (moisture trapping layer). At this point, the sealing resin sheet was made using a heat roll having a roll diameter of 100 mm and a temperature of 150° C. at a speed of 1 m/min. Thereafter, this was cut into a 9 cm square.

On the other hand, a 10 cm square glass substrate having a thickness of 1 mm was prepared. On this glass substrate, transparent electrodes (ITO), each having a width of 1 mm, were evaporated with a pitch of 2 mm. Then, a 5 cm square PET film having a thickness of 0.1 mm was mounted on the center portion of the glass substrate. These operations were conducted in a dry box.

Next, also in a dry box, the sealing resin sheet explained earlier that is cut into a 9 cm square was mounted on the glass substrate having the PET film mounted on the center portion thereof, facing the innermost absorbent film to the glass substrate. Then, 2 mm of the edge portions on the four sides of the sealing resin sheet were pressed with a heat bar at a temperature of 150° C. for five seconds to be fusion bonded to the glass substrate, thus making test sample 1. In this test sample 1, the initial moisture content of the PET film sealed with the sealing resin sheet was 100 ppm.

(Test Sample 2)

For a test sample 2, a molded stainless steel body was prepared instead of the sealing resin sheet used in the above-described test sample 1. In the molded stainless steel body, a 5 cm-square center portion of a 9 cm square stainless steel plate having a thickness of 0.1 mm was drawn to have a depth of 1 mm. In the depressed portion of the molded stainless steel body, 10 g of calcium oxide was sealed as drying agent, and this portion was covered with PET adhesive tape so that calcium oxide will not spill out.

Moreover, a glass substrate having a PET film mounted on the center portion thereof was prepared in a similar manner to that of test sample 1. UV curing resin was applied to have a thickness of 20 μm within 2 mm of the peripheral portion of the 9 cm-square center portion of the glass substrate (2 mm inside the 9 cm square portion), and the aforementioned molded stainless steel body was mounted thereon. Then, ultraviolet was irradiated from the glass substrate side to cure the UV curing resin, thus joining the glass substrate and the molded stainless steel body together to make test sample 2. In this test sample 2, the initial moisture content of the PET film sealed with the molded stainless steel body was also 100 ppm.

(Test Method)

Test samples 1 and 2 prepared in the above described way were left at a temperature of 60° C. and a relative humidity (RH) of 95% for 30 days. Then, the moisture contents of the internal PET films were measured.

(Test Result)

In test sample 2, the moisture content of the internal PET film was increased to 120 ppm. On the other hand, in test sample 1, the moisture content of the inside PET film was still 100 ppm, which revealed that the moisture content did not increase at all from the initial moisture content.

From this result, it was confirmed that test sample 1 having a sealing structure with the sealing resin sheet had an excellent waterproof performance. Therefore, the EL display device 10 according to the present embodiment, which is constituted by sealing the EL element using the same sealing structure as that of test sample 1, has an extremely low possibility of the characteristic deterioration of the device due to moisture, thus making it possible to achieve the long lifetime of the device.

Note that the present invention is not limited to the aforementioned embodiment and various modifications are possible.

For example, in the aforementioned embodiment, an organic EL display device made of a stack, in which the light-emitting portion 22 includes the organic light-emitting layer 28, was described. However, it is obvious that the EL display device 10 according to the present invention is not limited to an organic EL display device, and that the present invention can also be applied to an inorganic EL display device. In this case, a light-emitting portion can be made of a stack including an inorganic light-emitting layer. For example, the light-emitting portion can be made by stacking an inorganic light-emitting layer and a dielectric layer in this order on the transparent electrodes.

Moreover, in the aforementioned embodiment, the sealing resin sheet 16 is located so as to cover over the transparent electrodes 18 and the back electrodes 20 for sealing. This makes it possible to extend the electrodes to the outside from the sealed portion, while suitably protecting the internal EL element 14. However, the present invention is not limited to this type of structure in which the electrodes are covered and sealed, and the electrodes may be arranged in a different configuration.

From the hitherto-described description of the present invention, it is obvious that the present invention can be modified in various ways. Such modifications can not be recognized if they depart from the spirit and scope of the present invention. It should also be appreciated that improvements obvious to those skilled in the art are included in the following claims.

### INDUSTRIAL APPLICABILITY

According to the present invention, a small EL display device capable of sufficiently suppressing an EL element from being wet to achieve the long lifetime thereof is provided.

1. An electroluminescence display device comprising:
a transparent substrate;
an electroluminescence element provided on the transparent substrate; and
a sealing resin sheet having a function of moisture absorption, the sealing resin sheet being fusion bonded to the transparent substrate by heat to seal the electroluminescence element between the sealing resin sheet and the transparent substrate.

2. The electroluminescence display device according to claim 1, wherein the sealing resin sheet is fusion bonded to the transparent substrate by heat through a peripheral portion of the sealing resin sheet.

3. The electroluminescence display device according to any one of claims 1 and 2, wherein the sealing resin sheet has a moisture trapping layer in which inorganic filler having a function of moisture absorption is added to thermoplastic resin.

4. The electroluminescence display device according to claim 3, wherein the thermoplastic resin is any one of polyolefin and modified polyolefin which is adhesive.

5. The electroluminescence display device according to any one of claims 3 and 4, wherein the inorganic filler contains at least any one of magnesium sulfate, calcium oxide, and calcined hydrotalcite.

6. The electroluminescence display device according to any one of claims 3 to 5, wherein the sealing resin sheet has a metal layer on the outer side of the moisture trapping layer with respect to the electroluminescence element.

7. The electroluminescence display device according to claim 6, wherein the sealing resin sheet has a protective layer for protecting the metal layer.

8. The electroluminescence display device according to any one of claims 1 to 7, wherein the sealing resin sheet is embossed to have a size capable of housing the electroluminescence element.

9. The electroluminescence display device according to any one of claims 1 to 8, wherein the electroluminescence element is an organic electroluminescence element.

10. A sealing resin sheet used in the electroluminescence display device according to claim 1, the sealing resin sheet having a function of moisture absorption and being fusion bonded to the transparent substrate by heat to be capable of sealing the electroluminescence element between the sealing resin sheet and the transparent substrate.
